(19) United States
(12) Patent Application Publication
(10) Pub. No.: US 2002/0035777 A1
(43) Pub. Date: Mar. 28, 2002

(54) Manufacturing method and manufacturing apparatus for magnetic head slider and head gimbal assembly

(76) Inventors: Kiyoshi Hashimoto, Odawara (JP); Masaaki Matsumoto, Fujisawa (JP)

Correspondence Address: MATTINGLY, STANGER & MALUR P.C., ATTORNEYS AT LAW, 1800 DIAGONAL ROAD, SUITE 370, ALEXANDRIA, VA, 22314, US

(21) Appl. No.: 09/935,171

(22) Filed: Aug. 23, 2001

(30) Foreign Application Priority Data
Sep. 26, 2000 (JP) 2000-297070

(51) Int. Cl. G11B 5/127; H04R 31/00; H01R 3/00

(52) U.S. Cl. 29/603.09; 29/603.08; 29/603.07; 29/729; 29/737

(57) ABSTRACT

With negative pressure sliders having step bearings, there are variations in flying height resulting from variations in shape factors, such as the step bearing depth. In order to achieve lower flying height, it is considered necessary to reduce the variation in flying height caused by the variation in curvature of the air bearing surface and the variation in flying height caused by the variation in the shapes of the step bearings. The curvature of the air bearing surface of the slider can be observed in the pre-cut row bar condition or in a unit product condition. Shape data of the magnetic head slider can be input, such as the step bearing depth, etc., so as to calculate the predicted flying height of the slider An arithmetic processing unit calculates an adjusted target curvature from the difference between the predicted flying height and the target flying height.

### BACKGROUND OF THE INVENTION

1. Field of the Invention

This invention relates to a magnetic head slider and head gimbal assembly, and to a manufacturing method and manufacturing apparatus therefor, and more particularly to manufacturing technology for reducing the variation in flying height among the individual magnetic head sliders and head gimbal assemblies manufactured.

2. Description of the Related Art

In a magnetic disk drive, a magnetic head slider is used that flies while maintaining a minute interval between itself and a disk recording medium that rotates. Ordinarily, the slider will comprise, at the leading edge thereof, a magnetic transducer for recording information on and playing back information from the disk recording medium, and is subject to demands to make the bit density higher and the track width narrower in order to realize higher recording density. It is particularly demanded that the slider be made to fly in a condition of low flying height wherein it is made to approach as close as possible to the disk recording medium, in order to raise the bit density. In order to implement data recording and playback with sufficient reliability in such a low-flying-height condition, a critically important task is that of lowering the flying height differences, that is, the variation in the flying height, between individual manufactured sliders.

The negative pressure slider is effective in reducing flying height variation, and is widely and generally used. With the negative pressure slider, because of the high rigidity of the air film that develops between the disk recording medium and the flotation surface, it is possible to reduce flying height variation and fluctuation that arise from the static attitude and load wherewith the suspension supporting the slider presses against the disk recording medium, suspension vibration, and disk waviness in the disk recording medium, etc., and thus the negative pressure slider is effective in effecting lower flying height.

Nevertheless, the demands for lower flying height are becoming increasingly severe year by year, with efforts being made to achieve a flying height of 10 nm in the face of demands to lower the flying height as much as possible in a condition wherein no contact with the disk recording medium occurs. It is in this area of such low flying height that variation in the flying height among individual manufactured sliders becomes particularly problematic. If there is a variation of 5 nm in the flying height in sliders designed for a flying height of 10 nm, for example, changes of only 5 nm will be allowed in the flying height variation associated with the surface roughness of the slider and disk recording medium, the surface waviness of disk recording medium, and environmental variation (in pressure, temperature, etc.). Accordingly, in order to achieve lower flying height, in addition to reducing flying height variation induced by environmental changes or undulations and surface roughness that are physical flying height loss [factors], the variation in flying height among individual manufactured sliders must also be reduced.

Manufacturing methods and manufacturing apparatuses for reducing such flying height variation among individual manufactured sliders are disclosed, for example, in Japanese Patent Application Laid-Open No. H6-84312/1994 (published), U.S. Pat. No. 6,073,337, and Japanese Patent Application Laid-Open No. H11-328643/1999 (published). These are manufacturing methods and manufacturing apparatuses that adjust the curvature of the air bearing surface by subjecting the back surface of the slider to laser machining, the basic ideas whereof are as follows.

First, notice is taken of the fact that one of the manufacturing variation factors that has the greatest effect on flying height variation is the curvature of the air bearing surface. The curvature of the air bearing surface is expressed by the crown, defined as the amount of unevenness from a hypothetically flat plane (curvature∞) looking in the long direction of the slider, the camber, defined as the amount of unevenness from a hypothetically flat plane looking in the short direction of the slider, and the twist, defined as the difference in elevation looking in the diagonal direction of the slider. The curvature of the air bearing surface affects the air pressure produced between the air bearing surface and the disk recording medium and causes the flying height to vary. It is know that, in particular, the crown [factor] in the curvature of the air bearing surface has the greatest effect on the flying height, followed by camber and then twist.

Accordingly, with the manufacturing methods and manufacturing apparatuses disclosed in the patents noted earlier, stress in the back surface of the slider that has developed during the lapping process in the row bar condition (prior to cutting the slider chips) is melted with a laser, the stress is released, causing the condition of curvature in the air bearing surface to change, and curvature [factors] of the air bearing surface such as the crown are adjusted. By preprogramming the relationship between the laser machining amount, position, and machining pattern and the like and the curvature of the air bearing surface, moreover, the curvature of the air bearing surface can, with a number of repeated machinings, be made to approach close to the design value. The manufacturing methods and manufacturing apparatuses noted above can dramatically reduce the flying height variation resulting from curvature variation in the air bearing surface, and now constitute effective manufacturing technologies for realizing low flying height (of 10 to 25 nm or so) in sliders.

At flying heights of 25 nm or less, the step negative pressure slider is used which sharply reduces the variation in flying height relative to changes in temperature and atmospheric pressure. In the step negative pressure slider, as described in detail in Japanese Patent Application Laid-Open No. 2000-57724 (published), step bearings are adopted which have a submicron or smaller depth of large air bearing effect, and a negative pressure channel is designed at a depth where the negative pressure generated in the negative pressure channel becomes maximum. Thereby, a larger negative pressure can be utilized as compared to a conventional negative pressure slider, wherefore the rigidity of the air film becomes even higher, and the flying height variation caused by changes in the static attitude and the load wherewith the suspension presses on the disk recording medium is reduced.

The particulars relating to this reduction in flying height variation also apply to a head gimbal assembly. What should be given attention here is the technology, disclosed in U.S. Pat. No. 6,011,239, for adjusting the load and static attitude of the suspension, by applying laser processing to the suspension, so that the flying height while the slider is being made to fly coincides with the design value. The manufacturing technology disclosed here is aimed at the realization of sliders that exhibit small flying height variation.

### SUMMARY OF THE INVENTION

However, step bearings of submicron or smaller depth require high machining precision and have a great effect on flying height variation. Also, because the flying height variation is reduced by adjusting the curvature of the air bearing surface as described earlier, the main cause of flying height variation in a step negative pressure slider becomes the variation in the depth of the step bearings. Furthermore, because the step bearings are formed by a machining method such as ion milling, the numerical quantities machined at one time are large, and [flying height variation] appears as a shift in the average value of the flying height in units of [whole] lots. Because the flying height average value shift greatly influences slider flying height yield, difficult cost-related problems sometimes develop.

Such flying height average value shifts cannot be resolved merely by regulating the machining so that the curvature is kept to that which is determined by certain specifications as conventionally. As flying heights become increasingly lower, the seriousness of flying height variation induced by flying height average value shift will increase. In order to resolve this [problem], the objective must be made that of minimizing flying height variation between individual manufactured sliders, and not merely that of minimizing manufacturing variation such as in air bearing surface curvature and the like.

An object of the present invention is to provide a manufacturing method wherewith the flying height of a magnetic head slider is predicted from shape data thereof, and flying height variation is reduced by adjusting the curvature of the air bearing surface according to the predicted flying height, together with a manufacturing apparatus using that method, and also a head gimbal assembly and magnetic disk drive wherein a magnetic head slider manufactured with that manufacturing apparatus is mounted.

In order to attain the object noted above, the magnetic head slider manufacturing method of the present invention comprises the steps of: inputting slider shape data; calculating the predicted slider flying height, taking those shape data into consideration; calculating a target curvature for making adjustments from the difference in that predicted flying height and the desired target flying height; and adjusting the curvature of the air bearing surface to that target curvature.

Alternatively, [the magnetic head slider manufacturing method of the present invention] comprises the steps of: measuring slider shape data; calculating the predicted slider flying height, taking those shape data into consideration; calculating a target curvature for making adjustments from the difference in that predicted flying height and the desired target flying height; and adjusting the curvature of the air bearing surface to that target curvature.

By slider shape data are meant at least one type among the step bearing depth, negative pressure channel depth, rail width, and air bearing surface curvature.

The manufacturing apparatus for manufacturing a magnetic head slider by those manufacturing methods comprises: a slider shape data input unit, an arithmetic processing unit for calculating the predicted flying height of the slider, taking those shape data into consideration, and calculating a target curvature for making adjustments from the difference between that predicted flying height and the desired target flying height; and a control unit for adjusting the curvature of the air bearing surface to that target curvature.

Also, in order to attain the object stated above, the head gimbal assembly manufacturing method of the present invention comprises the steps of: inputting suspension shape data; calculating the predicted slider flying height taking those shape data into consideration; calculating a target curvature for making adjustments from the difference between that predicted flying height and the desired target flying height; and adjusting the curvature of the air bearing surface to that target curvature.

Alternatively, [the head gimbal assembly manufacturing method of the present invention] comprises the steps of: measuring suspension shape data; calculating the predicted slider flying height taking those shape data into consideration; calculating a target curvature for making adjustments from the difference between that predicted flying height and the desired target flying height; and adjusting the curvature of the air bearing surface to that target curvature.

### BRIEF DESCRIPTION OF THE DRAWINGS

FIG. 1 is a diagram representing a magnetic head slider manufacturing method and manufacturing apparatus according to a first embodiment aspect;

FIG. 2 is a diagonal view of a typical magnetic head slider, wherein the present invention can manifest effects, seen from the air bearing surface;

FIG. 3 is an arrow-view diagram of the section at the A-A′ line in FIG. 2;

FIG. 4 is a plan of a magnetic disk drive wherein is mounted a magnetic head slider relating to the present invention;

FIG. 5 is a flowchart for describing a magnetic head slider manufacturing method and manufacturing apparatus according to the first embodiment aspect of the present invention;

FIG. 6 is a diagonal view of a typical magnetic head slider, wherein the present invention can manifest effects, seen from the back surface thereof;

FIG. 7 is a graph that plots the relationship between the amount of shift in the depth δs of a step bearing in the slider diagrammed in FIG. 2 from the design value and the amount of flying height change in the vicinity of the leading edge;

FIG. 8 is a graph that plots the relationship between the amount of shift in the crown of the slider diagrammed in FIG. 2 from the design value and the amount of flying height change in the vicinity of the leading edge;

FIG. 9 is a model diagram for describing changes in the flying height of a magnetic head slider based on a conventional manufacturing method and manufacturing apparatus;

FIG. 10 is a model diagram for describing changes in the flying height of a magnetic head slider based on the manufacturing method and manufacturing apparatus of the present invention;

FIG. 11 is a diagram representing a magnetic head slider manufacturing method and manufacturing apparatus according to a second embodiment aspect of the present invention;

FIG. 12 is a diagram representing a magnetic head slider manufacturing method and manufacturing apparatus according to a third embodiment aspect of the present invention;

FIG. 13 is a flowchart for describing a magnetic head slider manufacturing method and manufacturing apparatus according to the third embodiment aspect of the present invention;

FIG. 14 is a diagonal view of a typical head gimbal assembly wherein the present invention can manifest effects;

FIG. 15 is a graph that plots the relationship between the amount of shift in the load of the head gimbal assembly diagrammed in FIG. 13 from the design value and the amount of flying height change in the vicinity of the leading edge;

FIG. 16 is a diagram representing a magnetic head slider manufacturing method and manufacturing apparatus according to a fourth embodiment aspect of the present invention;

FIG. 17 is a flowchart for describing the magnetic head slider manufacturing method and manufacturing apparatus according to the fourth embodiment aspect of the present invention;

FIG. 18 is a diagram representing a magnetic head slider manufacturing method and manufacturing apparatus according to a fifth embodiment aspect of the present invention;

FIG. 19 is a diagram representing a magnetic head slider manufacturing method and manufacturing apparatus according to a sixth embodiment aspect of the present invention; and

FIG. 20 is a flowchart for describing the magnetic head slider manufacturing method and manufacturing apparatus according to the sixth embodiment aspect of the present invention.

### DESCRIPTION OF THE PREFERRED EMBODIMENTS

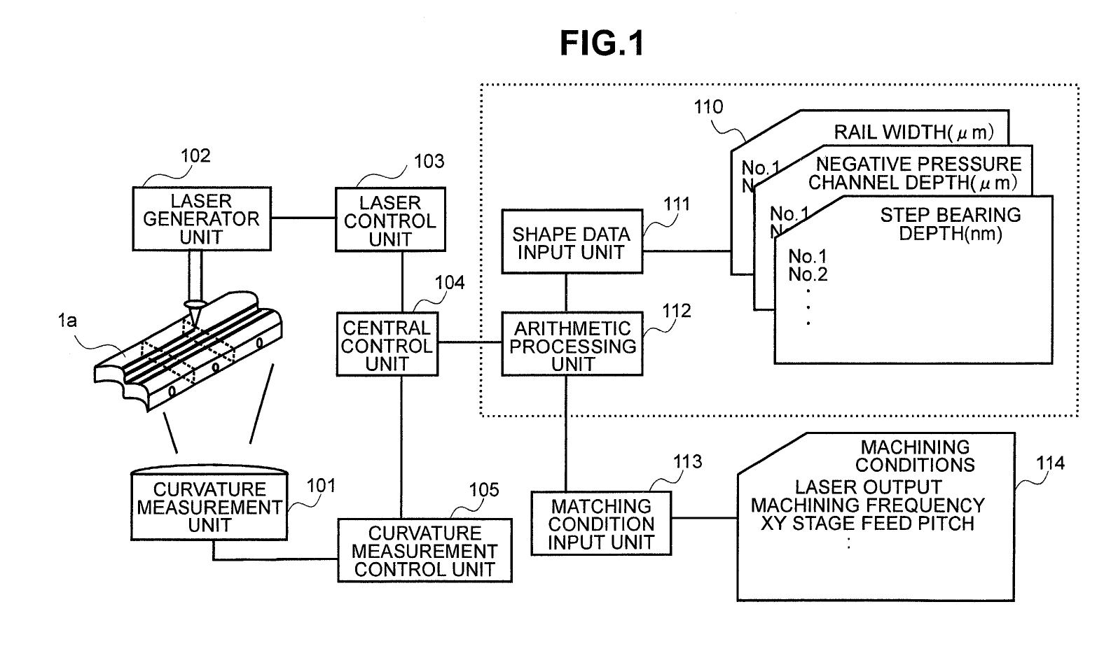

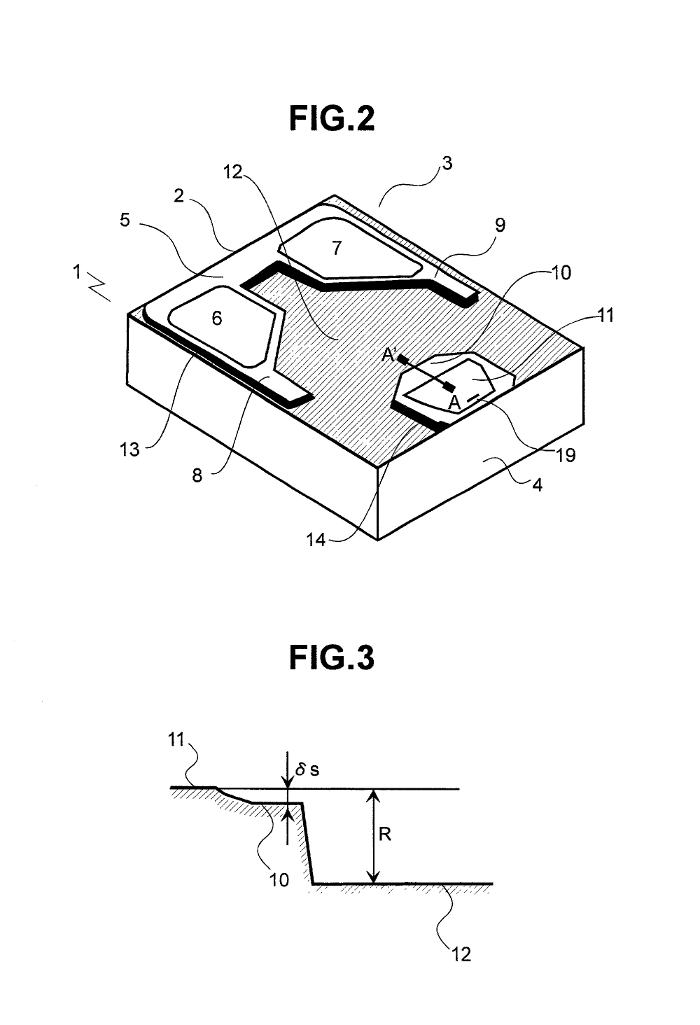

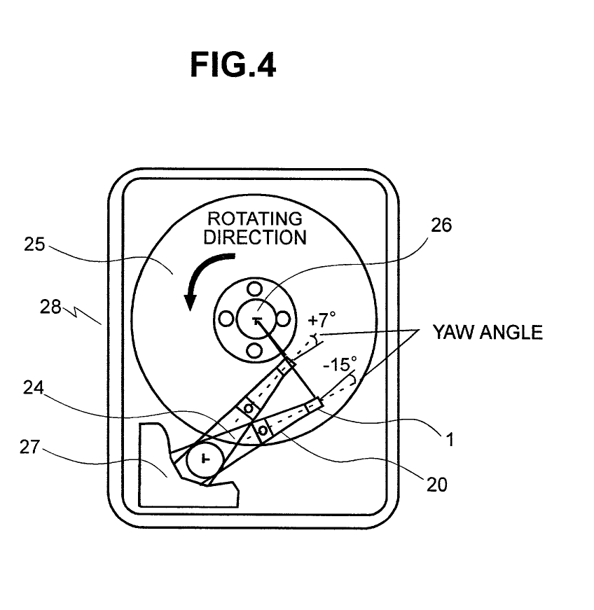

FIG. 1 is a diagram for describing a magnetic head slider manufacturing method and manufacturing apparatus according to a first embodiment aspect of the present invention. Before giving a detailed description of the present invention, the typical magnetic head slider diagrammed in FIG. 2 and the magnetic disk drive diagrammed in FIG. 4, wherein the present invention can manifest effects, are described.

The slider 1 diagrammed in FIG. 2 is configured so as to comprise an trailing edge 2, a air bearing surface 3, and an leading edge 4. Here the air bearing surface 3 of the slider 1 is configured of a front pad 13, a negative pressure channel 12, and a center pad 14, where in turn the front pad 13 is configured of a front step bearing 5 formed so as to continue from the trailing edge 2, a pair of side rail surfaces 6 and 7 formed so as to continue from that front step bearing 5, and a pair of side step bearings 8 and 9 having the same depth as the front step bearing 5, the negative pressure channel 12 is enclosed by the pair of side rail surfaces 6 and 7 and the pair of side step bearings 8 and 9, and the center pad 14 comprises a center rail surface 11 on the leading edge 4 side of the slider 1, and a rear step bearing 10 formed so as to enclose the center rail surface 11, at the same depth as the front step bearing 5.

The front step bearing 5 and the side step bearings 8 and 9 function as an air induction unit that efficiently forms a stiff air film (compressed air layer) between the air bearing surface 3 (bearing surface) and the surface opposite (the recording surface of the disk recording medium 25). This stiff air film functions to prevent direct contact between the air bearing surface 3 and the disk recording medium 25, to [facilitate] the slider 1 following the surface shape (deformations due to the crown and undulations) of the disk recording medium 25, and to maintain the flying height of the slider 1 constant.

The slider 1 diagrammed in FIG. 2 has a length of 1.25 mm, width of 1.0 mm, and thickness of 0.3 mm. The distance from the trailing edge 2 of the front step bearing 5 to the pair of [side] rail surfaces 6 and 7 is 0.08 mm. The depth δs of the front step bearing referenced to the pair of side rail surfaces 6 and 7, and to the center rail surface 11, is 150 nm. The maximum length of the pair of side rail surfaces 6 and 7 as seen in the long direction of the slider is 0.45 mm, the maximum width as seen in the short direction of the slider is 0.305 mm, and the maximum width is 0.68 times the maximum length. FIG. 3, which is an arrow-view diagram of the section at the A-A′ line in FIG. 2, is given for describing the correlations between the pair of side rail surfaces 6 and 7 and the center rail surface 11, the front step bearing 5, the side step bearings 8 and 9, the rear step bearing 10, and the negative pressure channel 12. The depth of the pair of side step bearings 8 and 9 and of the rear step bearing 10 in FIG. 3 is the same as the depth δs=150 nm of the front step bearing 5 as already noted (hereinafter sometimes collectively referred to as the step bearings).

The depth R of the negative pressure channel 12 referenced to the pair of side rail surfaces 6 and 7, and to the center rail surface 11 (hereinafter sometimes referred to collectively as the rail surfaces) is 1 μm. The center rail surface 11 of the center pad 14 has a magnetic transducer 19 for recording information to and playing back information from the disk recording medium 25. And the curvature of the air bearing surface 3 of the slider 1 is expressed by the crown, camber, and twist as defined in the prior art.

A plan of the magnetic disk drive 28 wherein the slider 1 diagrammed in FIG. 2 is mounted is diagrammed in FIG. 4. The magnetic disk drive 28 has mounted therein a 2.5 type disk recording medium 25 that involves a yaw angle variation from approximately +7° to −15°. The yaw angle here is the angle subtended between the long direction of the slider 1 and the direction wherewith air flows in along the circumference of the disk recording medium 25 to the slider 1 due to a swinging movement produced by a rotating actuator 27, with the slider 1 positioned in opposition to the disk recording medium 25. As to the sign of the yaw angle, the direction wherein air flows in from the inner circumferential side of the disk recording medium 25 relative to the long direction of the slider 1 is expressed as positive. The magnetic disk drive 28 is configured of the disk recording medium 25 attached to a spindle 26 that rotates at a speed of 4200 rpm, and the slider 1 that is attached to the tip end of a suspension 20, through the suspension 20 and a carriage 24 [extending] from the rotating actuator 27. The slider 1 is pressed down with a force of 2.7 gf on the disk recording medium 25 by the suspension 20, and flies at a flying height of 22 nm or so from the disk recording medium 25 due to the infusion of an air flow produced by the rotating of the disk recording medium 25 between the slider 1 and the disk recording medium 25. The slider 1 is positioned precisely at any radial position, from approximately 15 to 29 mm, over the disk recording medium 25 by the rotating actuator 27, and information is recorded to and played back from the disk recording medium 25, at any position, by the magnetic transducer 19 mounted to the center pad 14 of the slider 1.

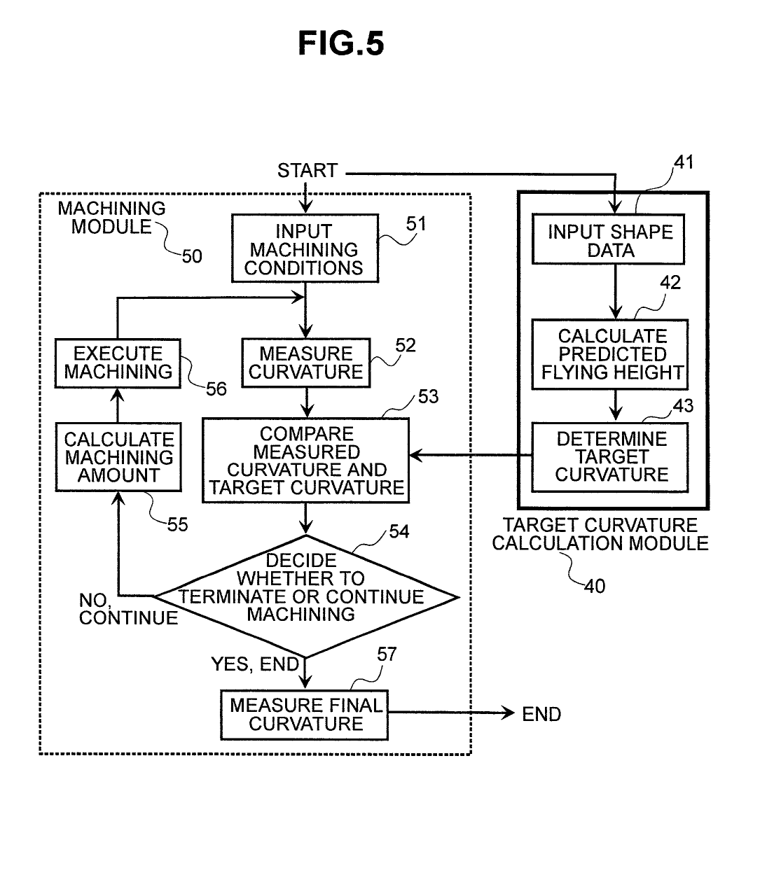

From this point forward the magnetic head slider manufacturing method and manufacturing apparatus according to the first embodiment aspect of the present invention are described with reference to the FIG. 1 and to the flowchart in FIG. 5. The first embodiment aspect of the present invention is configured of two large modules, as diagrammed in FIG. 5. One of these is a target curvature calculation module 40, which is characteristic of the present invention, and the other is a machining module 50 that adjusts the curvature of the air bearing surface 3 to the target curvature set by the target curvature calculation module 40 with a laser to the back surface 30 of the slider 1.

First, the target curvature calculation module 40 is configured with a flow that [begins with] a shape data input process 41 for setting the shape data 110 of the slider 1 (such data including, for example, the step bearing depth δs, negative pressure channel depth R, rail width, and air bearing surface curvature, etc.), [passes to] a flying height predicting process 42 for calculating the predicted flying height of the slider 1, taking the shape data into consideration, and reaches a target curvature determination process 43 for calculating the target curvature from the difference between the predicted flying height calculated in the flying height predicting process 42 and the target flying height. Furthermore, the step bearing depths δs used in the shape data 110 are deemed to be identical depths because, in this embodiment aspect, the front step bearing 5 and the side step bearings 8 and 9 are formed in the same machining process. Accordingly, it is only necessary to input [the depth at] any one location. In cases where the front step bearing 5 and the side step bearings 8 and 9 are produced in different machining processes, all of the step bearing depths may be input.

Similarly, the input of the curvature of the air bearing surface, as with the step bearing depth δs, may be done for any one of the front part, side parts, or rear part, or for all, and the input of the rail width may be any one of the [widths] of the side rail surfaces 6 and 7 or of the center rail surface 11 or may be all.

Here, the shape data input process 41 in FIG. 1 is executed by a shape data input unit 111, while the flying height predicting process 42 and the target curvature determination process 43 are executed by an arithmetic processing unit 112.

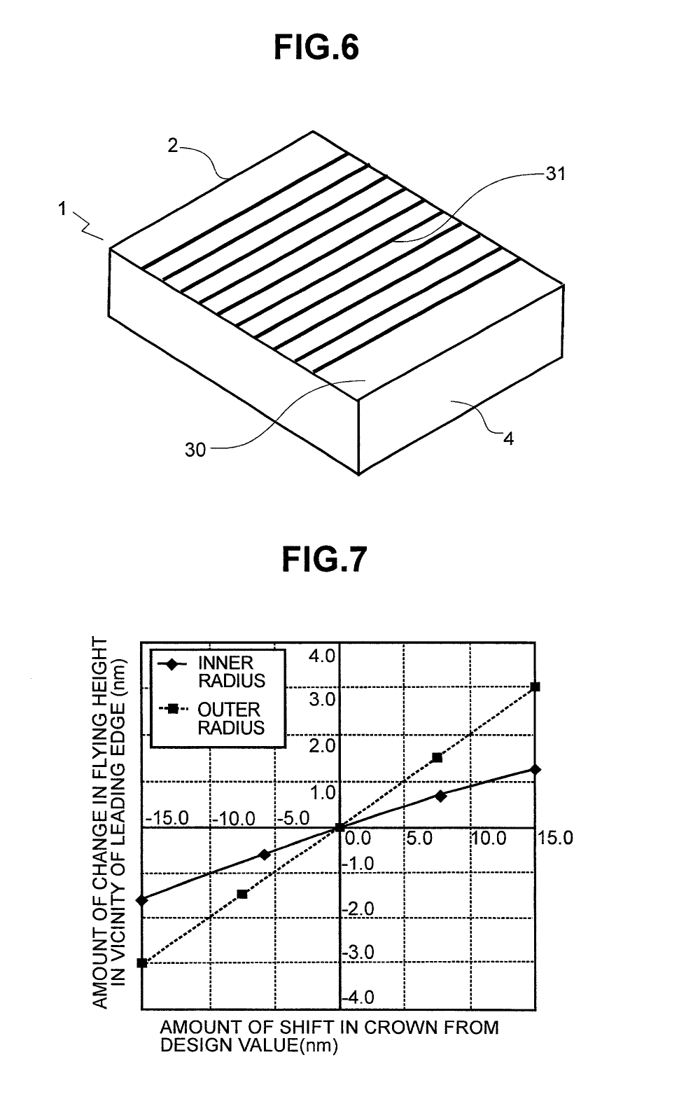

The machining module 50, on the other hand, is configured of a machining condition input process 51 for inputting such basic machining conditions as the relationship between the curvature of the air bearing surface 3 and the machining amount derived beforehand, laser intensity, machining frequency, and machining pattern, a curvature measurement process 52 for measuring the curvature of the air bearing surface 3, an adjusting curvature determination process 53 for comparing the target curvature determined by the target curvature calculation module 40 and the measured curvature measured by the curvature measurement process 52 and determining the adjusting curvature of the air bearing surface 3, a machining assessment process 54 for judging whether to continue or terminate machining, a machining amount calculation process 55 for determining the machining amount in accordance with the adjusting curvature, a machining process 56 for subjecting the back surface 30 of the slider 1 to laser machining in a machining pattern 31 such as diagrammed in FIG. 6, and a final curvature measurement process 57 for measuring the final curvature of the air bearing surface 3. When it is determined in the machining assessment process 54 to continue the machining, moreover, the machining amount calculation process 55 and then the machining process 56 are implemented, whereupon the curvature measurement process 52 is returned to again to constitute a closed loop.

Furthermore, the machining condition input process 51 in FIG. 1 is executed by a machining condition input unit 113 that inputs such initial machining conditions, in the machining conditions 114, as the number of the row bar 1a, the length of the row bar 1a, and the position where machining is implemented, etc. The curvature measurement process 52 and the final curvature measurement process 57 are executed in the adjusting curvature determination process 53, by a curvature measurement unit 101 controlled by a curvature measurement control unit 105, while the machining assessment process 54 and machining amount calculation process 55 that control the laser output, machining frequency, and such crown amounts as the feed pitch for the stage on which the row bar 1a is carried are executed by a central control unit 104. Then the machining process 56 is executed by a laser generator unit 102 that is controlled by a laser control unit 103, and the row bar 1a is machined. Finally, by a machining process not diagrammed, the slider is produced by cutting the row bar 1a at the positions indicated by the broken lines.

The example described in the foregoing is one wherein a laser is used as the method of adjusting the curvature of the air bearing surface 3, but other machining methods such as milling or scribing with a diamond needle, etc., that can alter the stress conditions in the air bearing surface 3 or back surface 30 in order to adjust the curvature of the air bearing surface 3, may also be used.

The [peculiar] characteristics of the magnetic head slider manufacturing method according to the first embodiment aspect of the present invention are to be found in the target curvature calculation module 40 for reducing flying height variation. Those characteristics are in having means for inputting shape data other than the curvature of the air bearing surface 3, and the determination, as the target curvature, of the curvature of the air bearing surface 3 at which an amount of flying height change occurs that cancels the amount of flying height change resulting from a shift from the design value in the shape data noted earlier, taking the shape data into consideration.

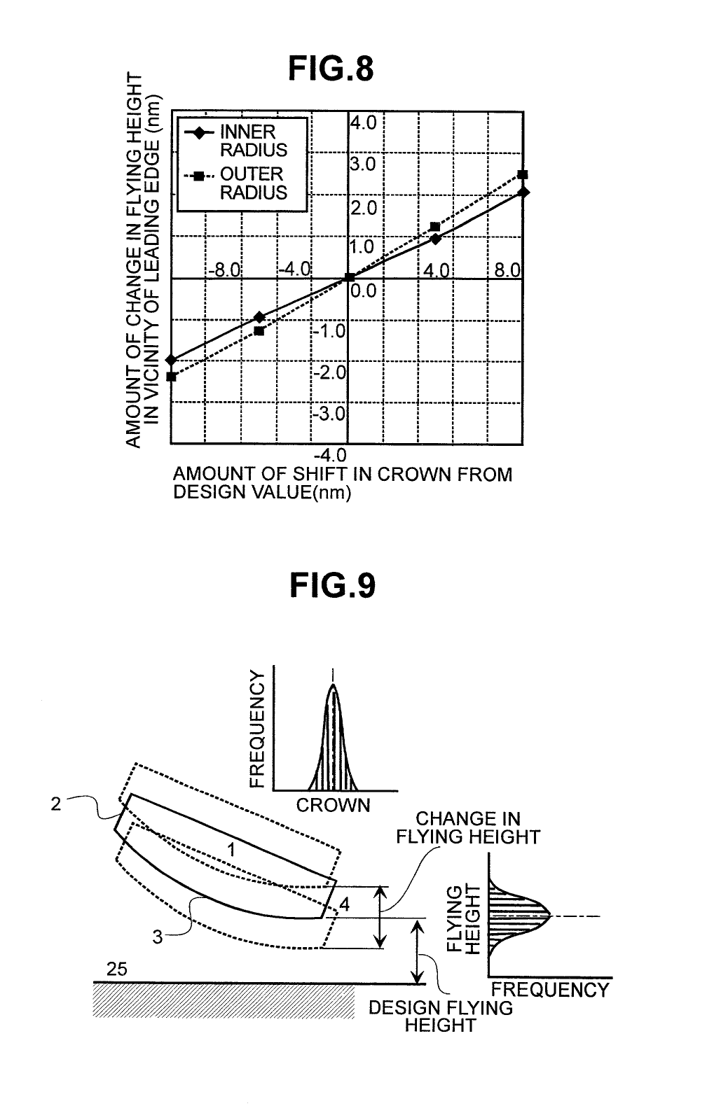

As an example, the flow of target curvature determination is described in a case where the step bearing depth δs has shifted from the design value. First, the amounts of change in the flying height in the vicinity of the leading edge 4 of the center rail surface 11 relative to the amount of shift from the design value for the step bearing depth δs are plotted in FIG. 7. In the amounts of change in the flying height plotted in FIG. 7 are indicated the changes when the slider 1 was positioned at a radial position of 15 mm (inner radius) and of 29 mm (outer radius), respectively, over the disk recording medium 25 in the magnetic disk drive 28. When the amount of shift from the design value for the step bearing depth δs was −10 nm, the amount of change in the flying height was approximately −1 nm at the inner radius and approximately −2 nm at the outer radius. Such changes in the amount of flying height occur similarly when the curvature of the air bearing surface 3 shifts from the design value. For example, the amount of change in the flying height in the vicinity of the leading edge 4 of the center rail surface 11 relative to the amount of shift from the design value of the crown of the slider 1 will be as plotted in FIG. 8. As will be understood from FIG. 8, when the amount of shift from the design value of the crown is +8 nm, the amount of change in flying height will be +1.7 nm at the inner radius and +2 nm at the outer radius. By using this property of the flying height being increased or decreased by these changes in the shape of the slider 1, the flying height can be adjusted to the target flying height. That is, by causing the crown to be altered +8 nm from the design value so that a change in flying height of approximately +2 nm will occur and thereby canceling the change in flying height of approximately −2 nm at the outer radius caused by the shift in the step bearing depth δs from the design value, the target flying height is maintained.

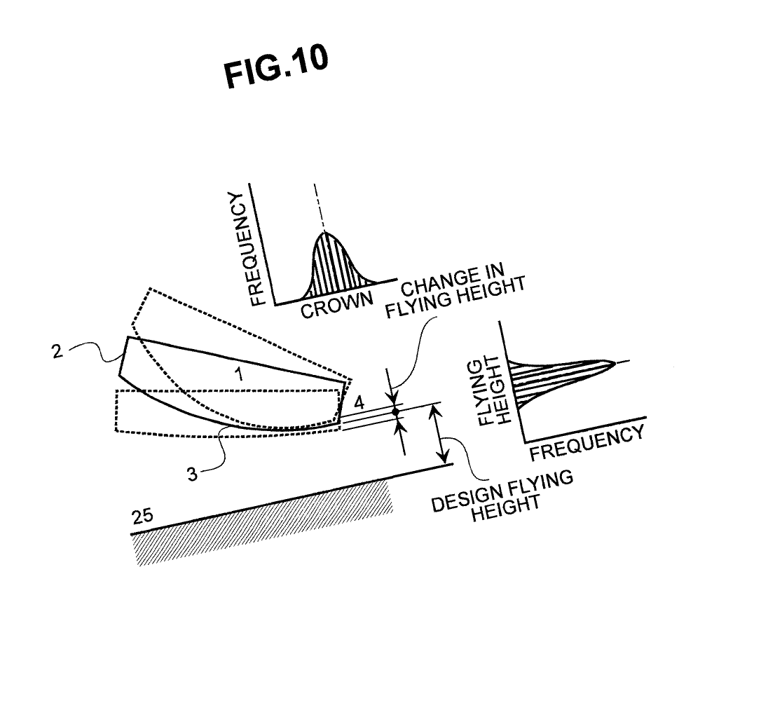

The effectiveness of the present invention is also described in comparison against the prior art. Model diagrams that compare the flying condition of a slider 1 based on a conventional manufacturing method and of the slider 1 based on the manufacturing method of the present invention are respectively given in FIG. 9 and FIG. 10. In the slider 1 based on the conventional manufacturing method diagrammed in FIG. 9, [sliders] having the same curvature in the air bearing surface 3 are manufactured, and the flying attitude does not greatly vary, but the flying height in the vicinity of the element cannot maintain the target flying height due to variation in shape [factors] other than curvature, such as the step bearing depth δs, etc. In the slider 1 based on the method of the present invention, on the other hand, the crown and flying attitude change, respectively, but the flying height in the vicinity of the element can support the target flying height. When this is compared with a crown and flying height distribution diagram, the effectiveness becomes patently clear. With respect to the curvature of the air bearing surface 3 of the slider 1 based on the manufacturing method of the present invention, the crown distribution widens because various different target curvature settings are made, taking shape [factors] other than curvature into consideration, but the flying height distribution narrows due to the effectiveness of trying to maintain the target flying height. With the slider 1 based on the conventional manufacturing method, on the other hand, the crown distribution relative to the design value will become narrow, but the flying height distribution will broaden.

In the first embodiment aspect of the present invention, for the example described in the foregoing, the measured data 110 for the step bearing depth δs are input in a shape data input unit 111 of the target curvature calculation module 40, the predicted flying height is calculated according to the amount of shift from the design value for the measured data 110 in an arithmetic processing unit 112, and, in the same arithmetic processing unit 112, a crown at which a change in flying height will occur that will cancel the difference between the predicted flying height and the target flying height is determined as the target curvature. Here, the calculation of the predicted flying height may be done using a sensitivity coefficient derived from the relationship between the amount of shift from the design value for the step bearing depth δs and the flying height found by simulation or the like [using] the finite-element method or the like, or it may be calculated directly with simulation [employing] the finite-element method or the like. Following thereupon, the curvature of the air bearing surface 3 is adjusted to the target curvature in each part of the machining module 50, and flying height variation in the slider 1 is reduced by maintaining the target flying height.

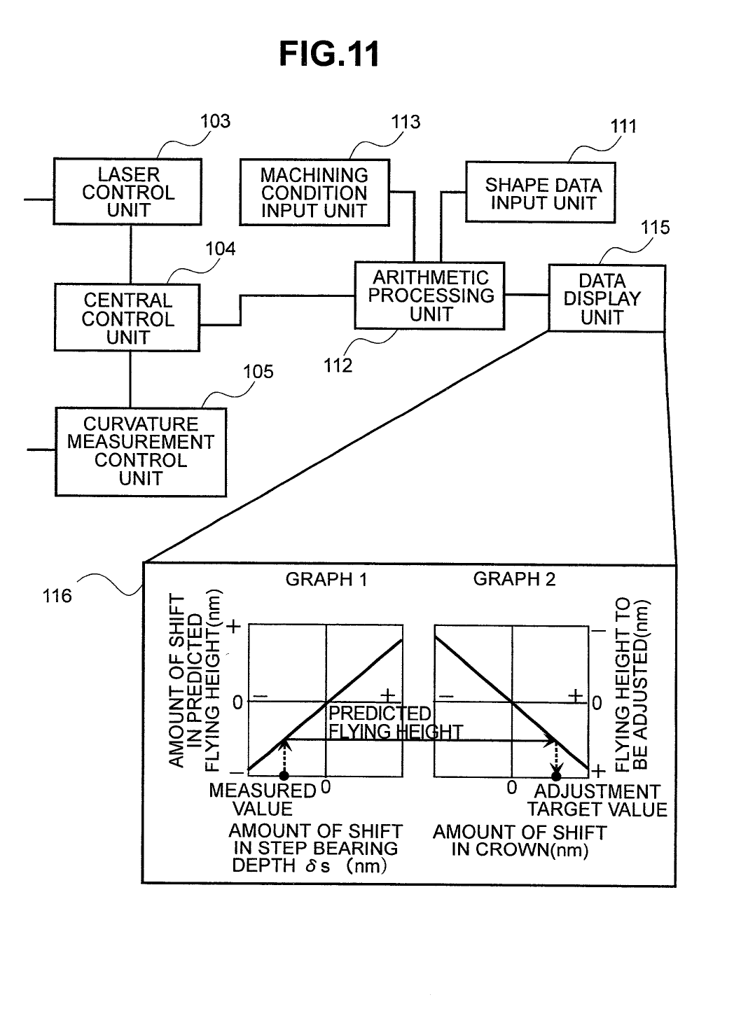

Based on a second embodiment aspect of the present invention, as diagrammed in FIG. 11, the flow of target curvature determination executed in the arithmetic processing unit 112 can be verified with numerical values or graphs with a data display unit 115 that can display [that flow].

Up to this point, the first embodiment aspect of the present invention has been described taking the step bearing depth δs as an example of slider 1 shape variation, but there are shape variations that cause the flying height to change other than the step bearing depth δs, such as the negative pressure channel depth R and the rail width, etc. If the variation in the flying height relative to these shape variations is first determined, it is possible then to set the target curvature from the relationship between the flying height and curvature [factors] such as the crown, as shown in FIG. 8.

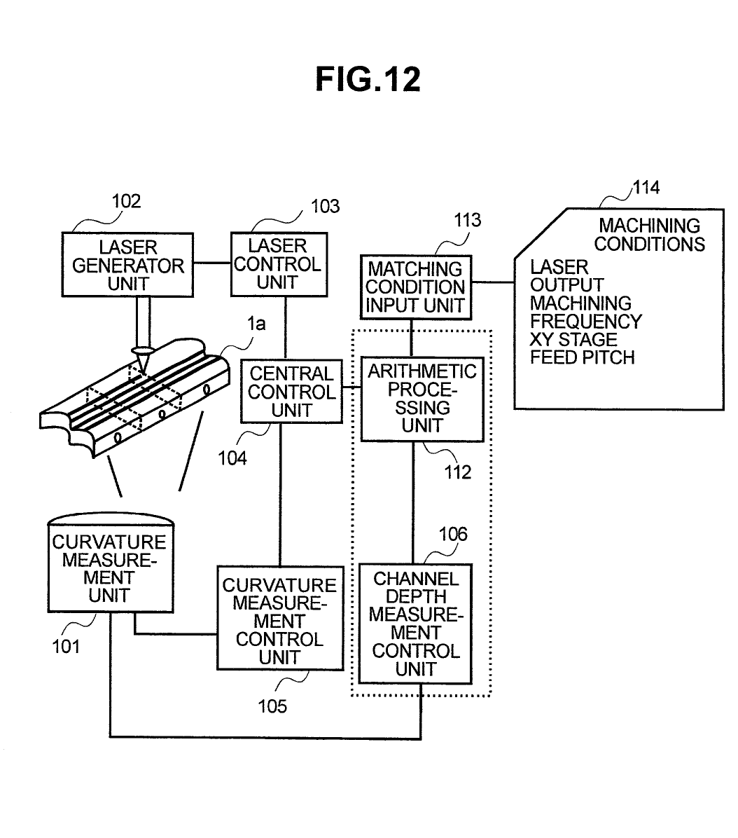

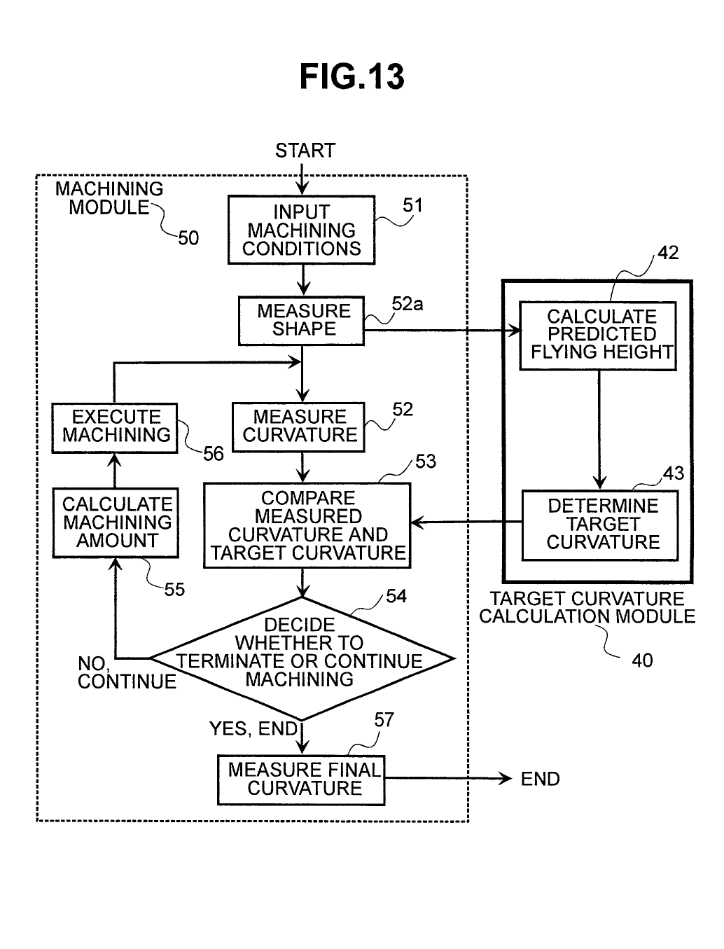

A magnetic head slider manufacturing method and manufacturing apparatus according to a third embodiment aspect of the present invention are described with reference to FIG. 12 and the flowchart in FIG. 13. In this third embodiment aspect, there is no shape data input unit 111 for inputting shape data 110 for the slider 1 as in the first embodiment aspect, and the target curvature calculation module 40 is configured by only the flying height predicting process 42 and the target curvature determination process 43. What is characteristic of the third embodiment aspect is that there is a shape measurement process 52a for measuring such shape data as the step bearing depth δs that is a feature of the curvature measurement unit 101. A channel depth measurement control unit 106 controls such [factors] as the magnification and focal point of a lens so as to match the air bearing surface, step surface, and negative pressure channel surface in order to measure the channel depth (i.e. the relative distance between the surfaces), and measures shape data using the curvature measurement unit 101. Then, by passing those shape data to the target curvature calculation module 40, shape data input is made unnecessary. Processes other than this shape measurement process are the same as in the first embodiment aspect. With this third embodiment aspect, by making the configuration in this manner, the need for other shape measurement equipment is eliminated, the curvature of the air bearing surface 3 can be effected, taking shape variation in the slider 1 into consideration, with the curvature adjustment apparatus only, and a slider 1 of small flying height variation can be manufactured.

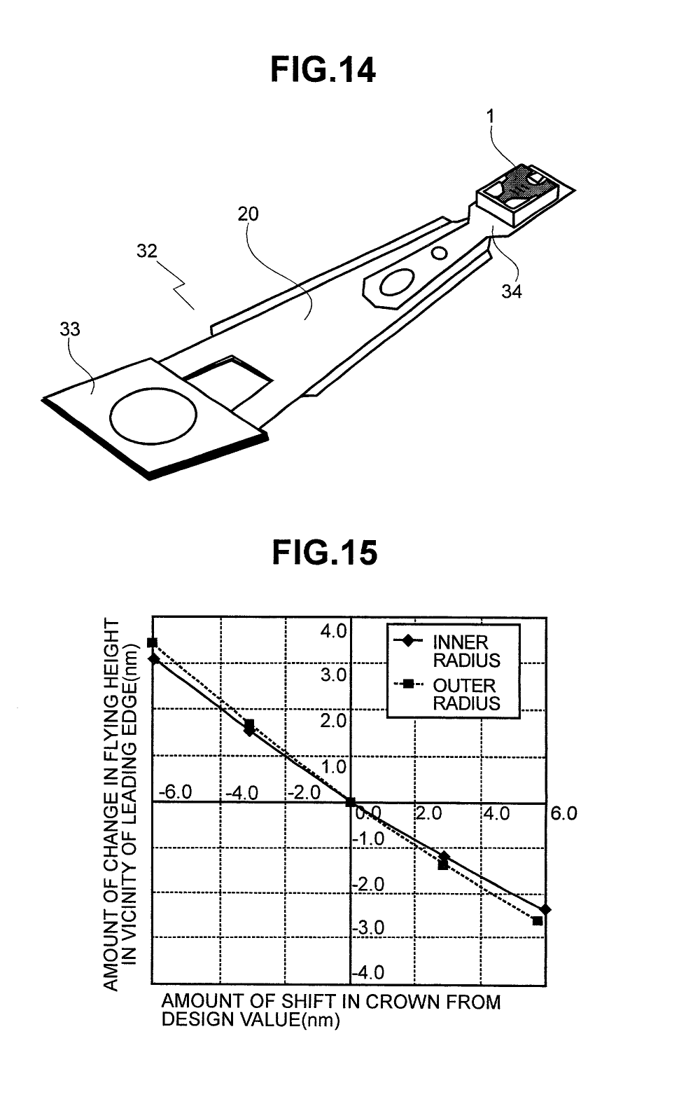

Next, an embodiment aspect of the present invention that reduces flying height variation in a head gimbal assembly condition is described. A typical head gimbal assembly 32 is diagrammed in FIG. 14. The head gimbal assembly 32 is structured such that a mount 33 for attaching it to the carriage 24 of the magnetic disk drive 28, a suspension 20 for generating a load for pressing the slider 1 against the disk recording medium 25 (which load is expressed hereinafter simply as the load), and a gimbal 34 for flexibly supporting the slider 1 at the tip end of the suspension 20 are attached thereto, with the back surface 30 of the slider 1 adhesively supported by the gimbal 34.

The dominant causes of flying height variation in the head gimbal assembly 32 are the load and static attitude of the suspension 20. The amounts of change in the flying height relative to amounts of shift in the pressing load of the suspension 20 from the design value are as plotted in FIG. 15. In FIG. 15, when the amount of shift in the load from the design value is 4 mN, the amount of change in the flying height is approximately—1.7 nm at the inner radius and approximately 2 nm at the outer radius. Accordingly, if the crown is shifted approximately +8 nm from the design target value in order to cancel the amount of change in the flying height produced by the shift in the load from the design value by the crown of the slider 1, the target flying height can be maintained, and flying height variation can be reduced.

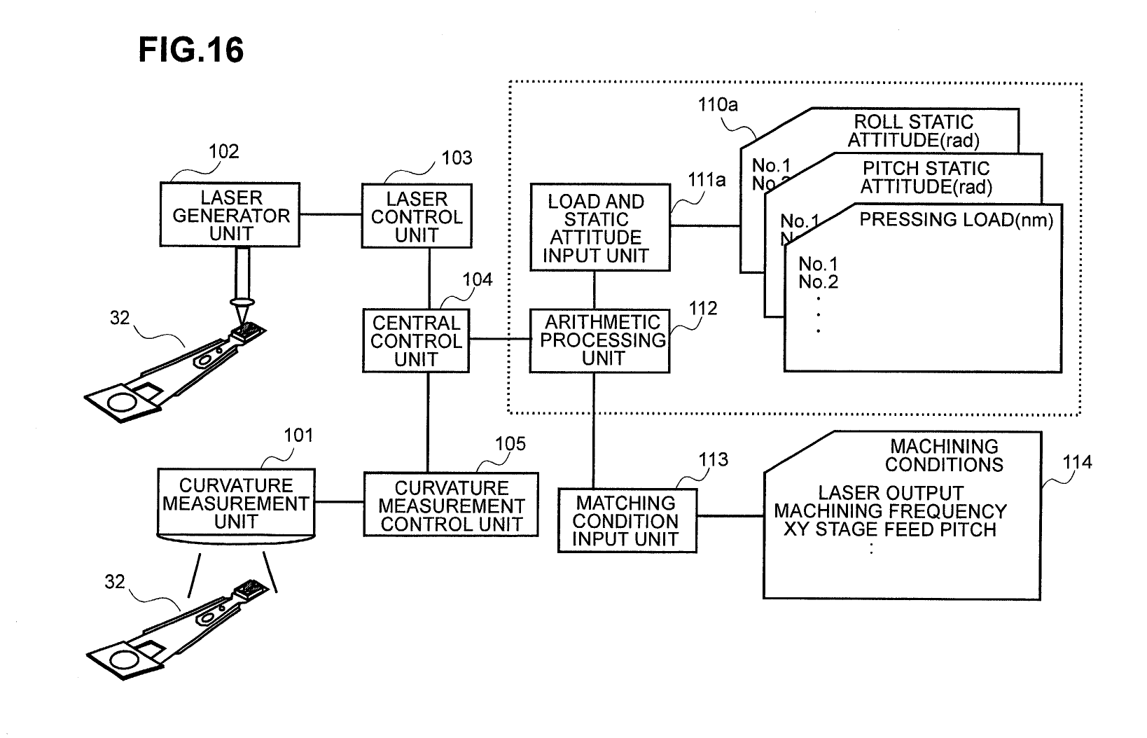

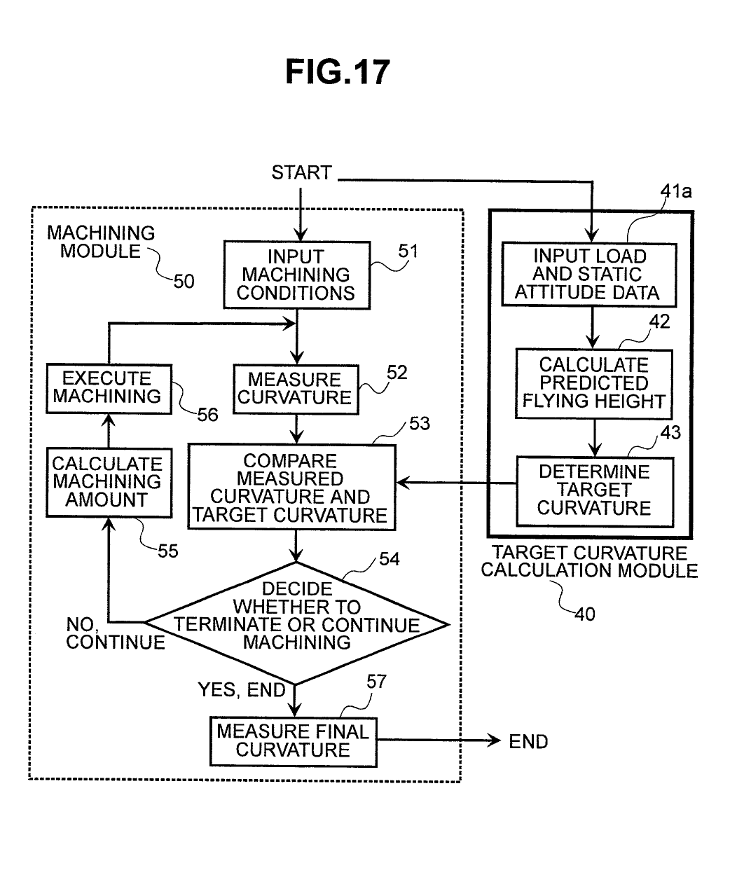

A head gimbal assembly manufacturing method and manufacturing apparatus according to a fourth embodiment aspect of the present invention are described with reference to FIG. 16 and the flowchart given in FIG. 17. This fourth embodiment aspect is configured by a target curvature calculation module 40 and a machining module 50 as is the first embodiment aspect. What is characteristic of the fourth embodiment aspect is that the target curvature calculation module 40 is configured by a flow that [begins with] a load and attitude angle data input process 41a for inputting load or static attitude data 110a for the head gimbal assembly 32, [passes to] a flying height prediction process 42 for calculating the predicted flying height, taking the load or static attitude data 110a into consideration, and reaches the target curvature determination process 43 for calculating the target curvature from the difference between the target flying height and the predicted flying height calculated in the flying height predicting process 42. Here, the load and attitude angle data input process 41a in FIG. 16 is executed by the load or static attitude data input unit 111, and the flying height predicting process 42 and target curvature determination process 43 are executed by the arithmetic processing unit 112. The machining module 50, on the other hand, except for the machining being carried on in the head gimbal assembly 32 condition, is the same as in the first embodiment aspect. Nevertheless, in cases where laser machining of the back surface 30 of the slider 1 is very difficult, if necessary, either laser machining, or milling or scribing with a diamond needle, etc., that can alter the stress conditions, may be implemented, from the air bearing surface 3 of the slider 1, or from the back surface side of the gimbal 34.

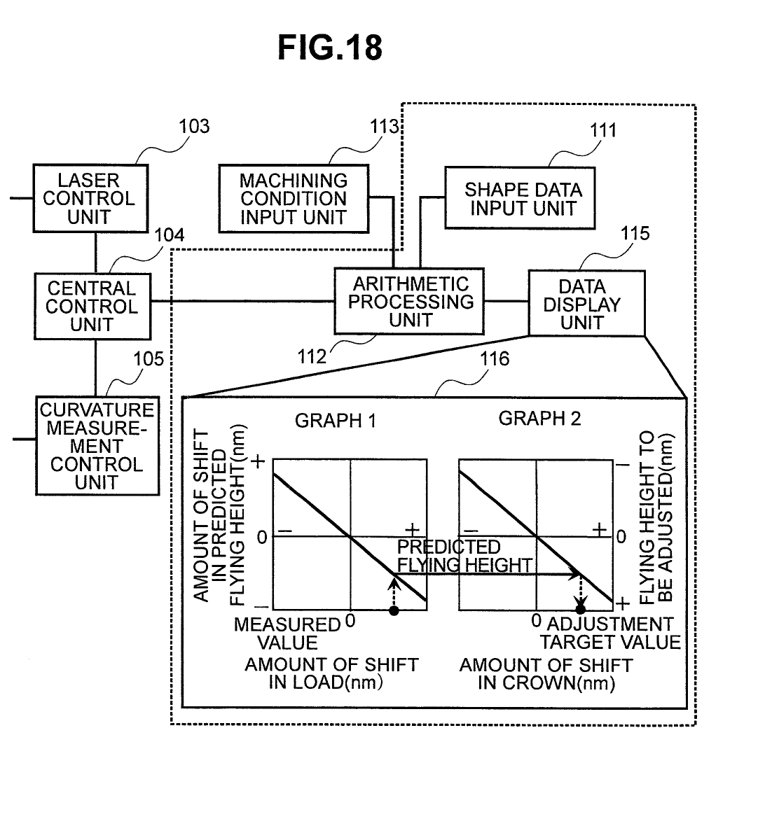

Based on a fifth embodiment aspect of the present invention, as diagrammed in FIG. 18, the flow of target curvature determination executed in the arithmetic processing unit 112 can be verified with numerical values or a graph with a data display unit 115 that can display [that flow].

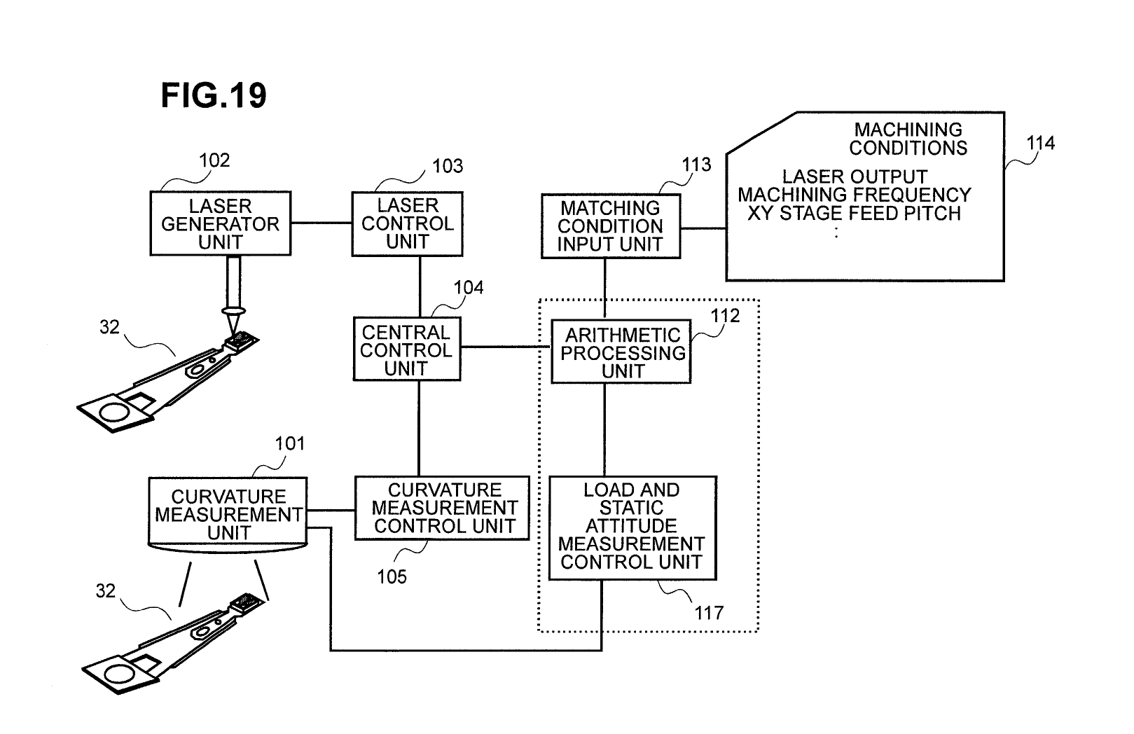

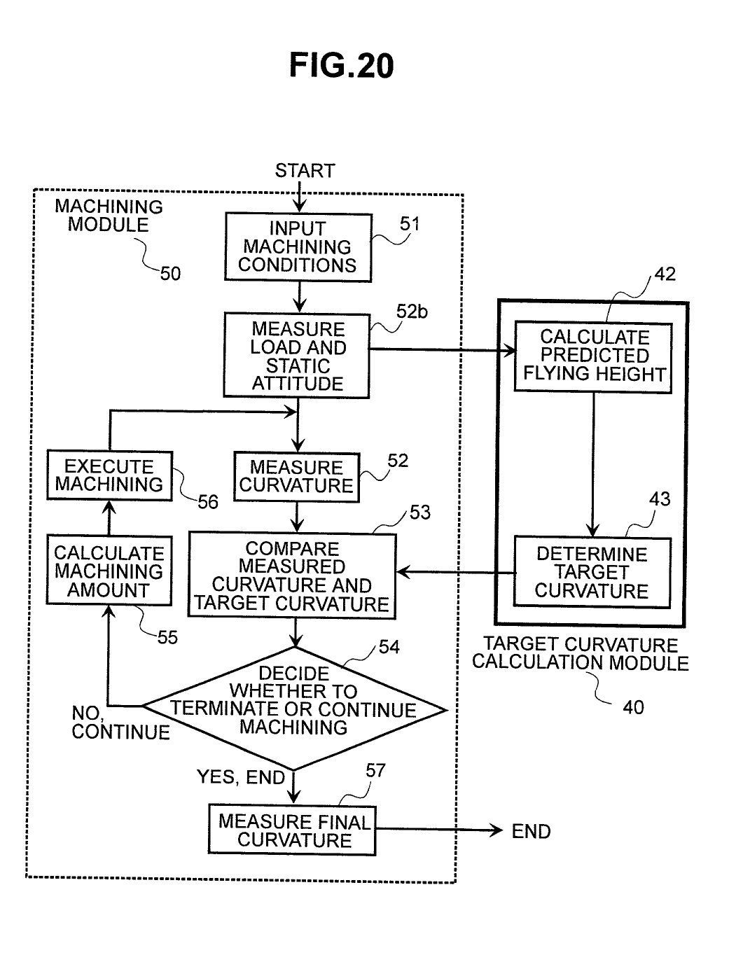

A head gimbal assembly manufacturing method and manufacturing apparatus according to a sixth embodiment aspect of the present invention are described with reference to FIG. 19 and the flowchart given in FIG. 20. In this sixth embodiment aspect, there is no data input unit 111a for inputting the load or static attitude data 110a of the head gimbal assembly 32 as in the fourth embodiment aspect, and the target curvature calculation module 40 is configured only of the flying height predicting process 42 and the target curvature determination process 43. The characteristic points in the sixth embodiment aspect are that there is a load and static attitude measurement process 52b for measuring the load or static attitude data that is a feature of the curvature measurement unit 101, and that those data are passed to the target curvature calculation module 40. The other processes are the same as in the fourth embodiment aspect. By configuring the sixth embodiment aspect as described in the foregoing, the need for other shape measurement equipment is eliminated, the adjustment of the curvature of the air bearing surface 3, taking variation in the load or static attitude of the head gimbal assembly 32 into consideration, can be realized with only the curvature adjustment apparatus, and a slider 1 of small flying height variation can be manufactured.

By adjusting the curvature of the air bearing surface according to the predicted flying height calculated while giving consideration to shape data such as slider channel depth and the like, magnetic head slider flying height variation can be reduced without narrowing manufacturing tolerances. Also, by adjusting the curvature of the air bearing surface according to the predicted flying height calculated from the pressing load or static attitude of the head gimbal assembly, head gimbal assemblies that exhibit small flying height variation can be realized. Furthermore, by reducing these flying height variations, the flying height of the magnetic head slider can be lowered.

What is claimed is:

1. A manufacturing method for a magnetic head slider comprising a magnetic transducer for recording information to and playing back information from a rotating recording medium, comprising the steps of:
inputting shape data for said slider;
calculating predicted flying height of said slider from air bearing surface, taking those shape data into consideration;
calculating an adjusting target curvature from difference between that predicted flying height and a desired target flying height; and
adjusting curvature of said air bearing surface to that target curvature.

2. A manufacturing method for a magnetic head slider comprising a magnetic transducer for recording information to and playing back information from a rotating recording medium, comprising the steps of:
measuring shape data for said slider;
calculating predicted flying height of said slider from air bearing surface, taking those shape data into consideration;
calculating an adjusting target curvature from difference between that predicted flying height and a desired target flying height; and
adjusting curvature of said air bearing surface to that target curvature.

3. The magnetic head slider manufacturing method according to claim 1, wherein said slider shape data refer to at least one of step bearing depth, negative pressure channel depth, rail width, and air bearing surface curvature.

4. The magnetic head slider manufacturing method according to claim 2, wherein said slider shape data refer to at least one of step bearing depth, negative pressure channel depth, rail width, and air bearing surface curvature.

5. A manufacturing method for a head gimbal assembly having a air bearing surface that flies in opposition to a rotating recording medium and is configured by a magnetic head slider having a magnetic transducer on said air bearing surface, a gimbal for supporting said slider, and a suspension for supporting said gimbal, comprising the steps of:
inputting shape data for said suspension;
calculating predicted flying height of said slider, taking those shape data into consideration;
calculating an adjusting target curvature from difference between that predicted flying height and a desired target flying height; and
adjusting curvature of said air bearing surface to that target curvature.

6. A manufacturing method for a head gimbal assembly having a air bearing surface that flies in opposition to a rotating recording medium and is configured by a magnetic head slider having a magnetic transducer on said air bearing surface, a gimbal for supporting said slider, and a suspension for supporting said gimbal, comprising the steps of:
measuring shape data for said suspension;
calculating predicted flying height of said slider, taking those shape data into consideration;
calculating an adjusting target curvature from difference between that predicted flying height and a desired target flying height; and
adjusting curvature of said air bearing surface to that target curvature.

7. The magnetic head slider manufacturing method according to claim 5, wherein said suspension shape data refer to a load under which the suspension is pressed against said recording medium and/or to static attitude [of said pressing].

8. The magnetic head slider manufacturing method according to claim 6, wherein said suspension shape data refer to a load under which the suspension is pressed against said recording medium and/or to static attitude [of said pressing].

9. A manufacturing apparatus for a magnetic head slider having a air bearing surface that flies in opposition to a rotating recording medium, comprises a magnetic transducer on said air bearing surface, and is supported by a gimbal made integral with a suspension at back surface of said air bearing surface, comprising:
means for inputting shape data for said slider;
means for calculating predicted flying height of said slider, taking those shape data into consideration;
means for calculating an adjusting target curvature from difference between that predicted flying height and a desired target flying height; and
means for adjusting curvature of said air bearing surface to that target curvature.

10. A manufacturing apparatus for a magnetic head slider having a air bearing surface that flies in opposition to a rotating recording medium, comprises a magnetic transducer on said air bearing surface, and is supported by a gimbal made integral with a suspension at back surface of said air bearing surface, comprising:
means for measuring shape data for said slider;
means for calculating predicted flying height of said slider, taking those shape data into consideration;
means for calculating an adjusting target curvature from difference between that predicted flying height and a desired target flying height; and
means for adjusting curvature of said air bearing surface to that target curvature.

11. The magnetic head slider manufacturing apparatus according to claim 9, wherein said slider shape data refer to at least one of step bearing depth, negative pressure channel depth, rail width, and air bearing surface curvature.

12. The magnetic head slider manufacturing apparatus according to claim 10, wherein said slider shape data refer to at least one of step bearing depth, negative pressure channel depth, rail width, and air bearing surface curvature.

13. The magnetic head slider manufacturing apparatus according to claim 9, [further] comprising means for displaying process stream for calculating said predicted flying height from said slider shape data and process stream for calculating said target curvature from that predicted flying height.

14. The magnetic head slider manufacturing apparatus according to claim 10, [further] comprising means for displaying process stream for calculating said predicted flying height from said slider shape data and process stream for calculating said target curvature from that predicted flying height.
